(19) United States
(12) Patent Application Publication
(10) Pub. No.: US 2011/0104415 A1
(43) Pub. Date: May 5, 2011

(54) PROCESS TO MANUFACTURE A REINFORCING ELEMENT PROVIDED WITH A CURED ADHESIVE COMPOSITION, REINFORCING ELEMENT AND RUBBER ARTICLE COMPRISING SAID REINFORCING ELEMENT

(75) Inventors: Johannes Gerardus Maria Aalbers, Erm (NL); Jan Jager, Klazienaveen (NL); Bastiaan Krins, Emmen (NL); Michael Henricus Jacobus Tweel Van Den, Leusden (NL)

(73) Assignee: POLYESTER HIGH PERFORMANCE GMBH, Obernburg (DE)

(21) Appl. No.: 12/997,934

(22) PCT Filed: Jun. 18, 2009
(86) PCT No.: PCT/EP2009/057601

§ 371 Date: Dec. 14, 2010

(30) Foreign Application Priority Data
Jun. 20, 2008 (EP) 08158647.1

(51) Int. Cl. B32B 1/08; B05D 5/10; B05D 3/00; B32B 25/08; C08L 63/00; C09K 19/52

(52) U.S. Cl. 428/36.8; 427/207.1; 428/492; 523/413; 525/122; 252/299.01

(57) ABSTRACT

A process to manufacture a reinforcing element provided with a cured adhesive composition, a reinforcing element provided with a cured adhesive composition, and a rubber article including the reinforcing element. The manufacturing process includes the steps of providing a reinforcing element, treating the reinforcing element with a composition that includes an aqueous dispersion of components, optionally drying the treated reinforcing element, and curing at least two of the components.

The present invention relates to a process to manufacture a reinforcing element provided with a cured adhesive composition, said reinforcing element obtained by the process and a rubber article comprising said reinforcing element.

Polyphenylene sulfide fibers are known to combine high strength with high chemical and thermal resistance. Consequently, polyphenylene sulfide fibers are used in applications, where said combination of properties is desired, as for example in reinforced rubber articles.

Polyphenylene sulfide merely consists of aromatic rings containing carbon-carbon bonds and carbon-hydrogen bonds, wherein said rings are linked by sulfur bridges. So, polyphenylene sulfide exhibits a high degree of chemical inertness, which is the reason for its high chemical and thermal resistance. Consequently, if polyphenylene sulfide fibers or fabrics are used as reinforcing elements for rubber articles, it is not surprising that there is practically no adhesion between the rubber article and the polyphenylene sulfide reinforcing element with disastrous consequences for the stability of the rubber article reinforced with a polyphenylene sulfide reinforcing element. So, an adhesive composition is needed, which, if applied to polyphenylene sulfide fibers, results in a reinforcing element exhibiting sufficient adhesion to rubber.

A known adhesive composition for enhancing the adhesion of relative inert reinforcing elements to rubber is a mixture of a rubber latex and a condensed product obtained by the reaction of resorcinol with an aldehyde, particularly formaldehyde, in the presence of a catalyst such as an alkaline material or even an acid material (generally called “RFL”). This RFL has been and is widely used as an adhesive liquid suitable for mass production.

However, the one-bath application of said RFL to polyphenylene sulfide cords and the incorporation of said RFL-treated polyphenylene sulfide cords as a reinforcing element into a rubber article results in a strap peel adhesion force between rubber and polyphenylene sulfide cord of merely 30 N/2 cm, which is far too low. Also with two-bath dipping, using a mixture of a blocked isocyanate and an epoxide predip in the first bath followed by the RFL-treatment in the second bath, the strap peel adhesion force does not increase.

Also reinforcing elements comprising a thermotropic liquid crystalline polymer exhibit a low adhesion to rubber, even if treated with the two bath dipping described above.

Therefore, the object of the present invention is to provide a reinforcing element comprising polyphenylene sulfide or a thermotropic liquid crystalline polymer provided with an adhesive composition, wherein said reinforcing element, if incorporated into a rubber article, results in a strap peel adhesion force (SPAF) between rubber and the reinforcing element, which is significantly higher than the SPAF between rubber and the same reinforcing element provided with an adhesive composition comprising RFL or comprising a predip and RFL.

Said object of the invention is achieved by a process to manufacture a reinforcing element provided with a cured adhesive composition, which process comprises the steps of
a) providing a reinforcing element comprising a sulfur-containing polymer or a thermotropic liquid crystalline polymer,
b) treating the reinforcing element provided in step a) with a composition, which contains an aqueous dispersion of components
   (i) at least one rubbery latex component,
   (ii) at least one water soluble or dispersible epoxide component, and
   (iii) at least one water soluble or dispersible polyfunctional amine curing agent selected from primary, secondary and tertiary amines and mixtures of said amines,
   wherein the solid content of the aqueous dispersion is from 1 to 50% by weight, resulting in a treated reinforcing element,
c) optionally drying the treated reinforcing element from step b) resulting in a reinforcing element containing the components (i), (ii) and (iii) and
d) curing at least components (ii) and (iii),
   wherein the steps are performed in the sequence
   α) a), b), c), d) or
   β) a), b), c), d), b), c), d) or
   γ) a), b), d), b), d) or
   δ) a), b), c), b), c), d),
   resulting in a reinforcing element provided with a cured adhesive composition.

If the reinforcing element comprising a sulfur-containing polymer or a thermotropic liquid crystalline polymer and provided with a cured adhesive composition according to the process of the present invention is incorporated into a rubber article and the strap peel adhesion force (SPAF) between rubber and said reinforcing element provided with said cured adhesive composition is measured, the SPAF is significantly higher than the SPAF of the same reinforcing element comprising the same sulfur-containing polymer or the same liquid crystalline polymer but provided with an adhesive composition comprising RFL or comprising a predip and RFL and incorporated into the same rubber article.

This is highly surprising in view of the facts that
sulfur containing polymers, especially polyphenylene sulfides, exhibit a high degree of chemical inertness and
thermotropic liquid crystalline polymers, especially thermotropic liquid crystalline polyesters consisting of p-oxybenzoyl moieties and 6-oxy-2-naphthoyl moieties, exhibit a high degree of crystallinity (e.g. up to more than 90%), so that most of the functional groups of said polymers are hidden within the crystal structure and therefore, are not available for adhesion generating chemistry.

According to the process of the present invention the reinforcing element is a sulfur-containing polymer or a liquid crystalline polymer.

Within the scope of the present invention the term “sulfur-containing polymer” has to be understood in its broadest sense. Therefore, the sulfur-containing polymer may be crosslinked. However, it is preferred, that the sulfur containing polymer is a non-crosslinked sulfur-containing polymer. In the scope of the process according to the present invention the term “non-crosslinked sulfur-containing polymer” generally means every non-crosslinked polymer material comprising sulfur bridges (—S—) and optionally other chemically inert bridging groups, carbon-hydrogen bonds and carbon-carbon bonds.

In a preferred embodiment of the present invention the non-crosslinked sulfur-containing polymer is a non-crosslinked polyarylene sulfide. In the scope of the process according to the present invention the term “non-crosslinked polyarylene sulfide” in his broadest sense is to be understood as linear or branched polymers containing arylene sulfide units. Polyarylene sulfides and their manufacture are described e.g. in “Ullmann's Encyclopedia of Industrial Chemistry”, Volume A21, B. Elvers, S. Hawkins und G. Schulz (Eds.), VCH, Weinheim-New York 1992, page 463-472. Polyarylene sulfides according to the present invention are non-crosslinked polyarylene thioethers having recurring units of formula (1)

—[(Ar¹)ₙ—X]ₘ—[(Ar²)ᵢ—Y]ⱼ—[(Ar³)ₖ—Z]ₗ—[(Ar⁴)ₒ—W]ₚ— (1)

wherein
Ar¹, Ar², Ar³, Ar⁴ and W, X, Y and Z, respectively, are—independent from one another—equal or nonequal,
the indexes n, m, i, j, k, I, o and p are—independent from one another—zero or integer numbers 1, 2, 3 or 4, their sum being at least 2,
Ar¹, Ar², Ar³ and Ar⁴ are arylene units having 6 to 18 carbon atoms and
W, X, Y and Z represent bivalent bridging units selected from —SO₂—, —S—, —SO—, —CO, —O—, —COO— and alkylene or alkylidene groups having 1 to 6 carbon atoms, wherein at least one of the bridging units is —S— and
the arylene units Ar¹, Ar², Ar³ und Ar⁴ may be substituted with inert chemical groups like methyl or ethyl groups and the like or nonsubstituted, the latter preferably being phenylene, biphenylene, naphthylene, anthracene and phenanthrene units.

In a preferred embodiment of the process according to the present invention the polyarylene sulfide contains at least 30 mol-%, more preferred at least 50 mol-% und especially preferred at least 70 mol-% arylene sulfide units.

A polyarylene sulfide, which is most preferred according to the process of the present invention is a linear polyphenylene sulfide (PPS) generally containing at least 50 mol-% and especially at least 70 mol-% phenylene sulfide units. An example for such a linear polyphenylene sulfide is known under the trade mark Fortron®.

Within the scope of the present invention the term “thermotropic liquid crystalline polymer” has to be understood to comprise any thermotropic liquid crystalline polymer like a thermotropic liquid crystalline polyester, e.g. consisting of p-oxybenzoyl moieties and 6-oxy-2-naphthoyl moieties.

The shape of the reinforcing element provided in step a) of the process according to the present invention can exhibit any geometry. In a preferred embodiment of the process according to the present invention the reinforcing element is fibrous. Within the scope of the process according to the present invention the term “fibrous” refers to any embodiment having its origin from fibers in general. Examples include staple fibers or filaments, woven or knitted fabrics, nonwovens, non-twisted or twisted yarns or cords, wherein non-twisted or twisted yarns and woven or knitted fabrics are especially preferred.

Referring to yarns those are preferred to be provided as reinforcing elements in step a) of the process of the present invention, which exhibit a tenacity in the range of 30 to 70 cN/tex, more preferably in the range of 40 to 60 cN/tex, an elongation at break between 15 and 30% and a yarn linear density in the range of 100 to 1600 dtex, more preferably in the range of 200 to 1200 dtex.

The yarns may consist of fibers of one chemical type, i.e. of fibers made of one of the sulfur-containing polymers or made of one of the thermotropic liquid crystalline polymers described before.

Alternatively, said yarns may comprise fibers made of a sulfur-containing polymer or fibers made of a thermotropic liquid crystalline polymer and may additionally contain fibers, which neither belong to the class of sulfur-containing polymers nor to the class of thermotropic liquid crystalline polymers with the proviso, that such yarns, so-called “hybrid yarns”, constitute a reinforcing element, which—if subjected to the process of the present invention—results in a reinforcing element provided with a cured adhesive composition, which after incorporation into a rubber article exhibits a SPAF significantly higher than the SPAF of the same hybrid yarn but, provided with an adhesive composition comprising RFL or comprising a predip and RFL and incorporated into the same rubber article.

In the scope of the process according to the present invention in step a) the term “providing” refers to any measure, which makes a reinforcing element ready for being treated in step b) of said process. Such measures include e.g. unwinding filaments or yarns and delivering the unwound filaments or yarns to the treatment of step b).

However, it is also possible to incorporate said providing of the reinforcing element in a manufacturing process of the reinforcing element, for example in a standard manufacturing process of fibers from linear polyphenylene sulfide. Such process is conducted as a one-step spin-draw-winding process, or as a two-step process, wherein spinning and drawing is separated and wherein drawing is for example performed by steam-draw-frames, hot plates or hot godets. The providing of the reinforcing element in such processes can be realized at any suitable stage within said processes, for example in a spin-draw-winding process after the spinning and before the drawing or after the drawing and before the winding.

As part of step a) it is possible to remove the spin finish used in the spinning and drawing process by physical means, preferably by washing or spraying with an appropriate solvent like acetone or water. Also increased temperatures can be used like a flame, hot plate, hot godet or hot oven in order to remove the spin finish. As an alternative, it is possible to place the reinforcing element in a bath with an appropriate solvent for some time before entering the following steps, preferably until said spin finish is dissolved in said solvent.

As a part of step a) it is also possible to perform a plasma treatment, corona treatment or any other treatment based on electronical discharge in order to modify the surface of the reinforcing element. This treatment can be performed in an air environment, but also any type of gas can be used like nitrogen or oxygen.

Most preferred is the combination of first removing the spin finish and then applying a plasma or corona treatment.

Whatever providing measure is used for the reinforcing element in step a) of the process according to the present invention, attention has to be paid, not to deteriorate the tenacity of the reinforcing element.

In step b) the reinforcing element provided in step a) is treated with a composition. In the scope of the process according to the present invention the term “treating” encompasses any method, known to the skilled person, to apply the composition to the reinforcing element provided in step a) including e.g. spraying, brushing or kissing the reinforcing element with the composition and preferably dipping the reinforcing element with the composition.

The composition used for treating the reinforcing element in step b) of the process according to the present invention is an aqueous dispersion containing the components (i), (ii) and (iii), which are described in more detail in the following.

Component (i) is at least one rubbery latex component. For those skilled in the art it is clear that said rubbery latex component should be compatible with the rubber type of the rubber article to which adhesion is sought. To this end, for example as rubbery latex components those latices are used that are based on vinyl pyridine (VP), ethylene propylene diene monomer (EPDM), butadiene acrylonitrile (NBR), chlorosulphonated ethylene (CSM), hydrogenated butadiene acrylonitrile (HNBR), chloroprene (CR), ethylene vinyl acetate (EVA), styrene butadiene rubber (SBR) or blends or copolymers thereof.

The skilled person knows such components and he has no difficulties in choosing the right latex component for a specific rubber type. A detailed description of systems suitable for this purpose is given in T. Takeyama and J Matsui, Rubber Chem. Technol. 42, 159-256 (1969), which is incorporated herein by reference in its entirety.

In the frame of this invention it is especially preferred to use a copolymer based on butadiene, vinyl pyridine and styrene as rubbery latex component. An example of a suitable component is a copolymer consisting of 70% of butadiene, 15% of vinylpyridine and 15% of styrene. Such component is e.g. offered under the trademark Pliocord® VP 106 by Eliokem, France.

Component (ii) is at least one water soluble or dispersible epoxide component. For the epoxide component such components are very suitable that have an average of 2 or more epoxide groups per molecule. These components are also known to those skilled in the art. Examples for suitable epoxide components are triglycidyl isocyanurate; 1-epoxyethyl-3,4-epoxycyclo-hexane; vinyl cyclohexene dioxide; ethylene glycol diglycidic ether; 1,2-propanediol diglycidic ether; 1,3-propanediol diglycidic ether; 2,3-butanediol diglycidic ether; and the glycidyl ethers of glycerol, erythritol, pentaerythritol, and sorbitol which contain two to three glycidic groups per molecule, for example, the diglycidyl ether of glycerol, the triglycidyl ether of hexanetriol and so forth. Still other epoxides can be used such as 3,4-epoxycyclohexyl methyl-3,4-epoxy cyclohexane carboxylate; 3-(3,4-epoxycyclohexane)-8,9-epoxy-2,4-dioxaspiro[5,5]-undecane; bis(2,3-epoxycyclopentyl)ether; bis(3,4-epoxy-6-methylcyclohexyl methyl) adipate; the diglycidyl ether of polyethylene glycol 400; polyallyl glycidyl ether; the diglycidyl ether of bisphenol A; epoxy resorcinol ethers and the like. Further examples encompass the water soluble polyglycidyl ethers including the polyhydroxylated saturated aliphatic hydrocarbons of from 2 to 10 carbon atoms. Mixtures of these epoxides can be used. Preferred ones are the polyglycerin glycidyl ethers (CAS-No. 118549-88-5). An example of a suitable epoxide component is a polymeric glycidyl ether which is offered under the naming GE 500 by Raschig, Germany.

Component (iii) is at least one water soluble or dispersible polyfunctional amine curing agent selected from primary, secondary and tertiary amines and mixtures of said amines. The amine curing agents are well known in the art and are used as curing agents for the epoxides. Examples of such amines are polyfunctional primary and secondary amines and some tertiary amines including, for example, diethylene triamine, triethylene tetramine, dicyandiamide, melamine, pyridine, cyclohexylamine, benzyldimethylamine, benzylamine, diethylaniline, triethanolamine, piperidine, tetramethyl piperazine, N,N-dibutyl-1,3-propane diamine, N,N-diethyl-1,3-propane diamine, 1,2-diamino-2-methylpropane, 2,3-diamino-2-methylbutane, 2,4-diamino-2-methylpentane, 2-diamino-2,6-dimethyloctane, dibutylamine, dioctylamine, dinonylamine, distearylamine, diallyl amine, dioleylamine, dicyclohexylamine, methylethylamine, ethylcyclohexylamine, o-tolylnaphthylamine, pyrrolidine, 2-methylpyrrolidine, tetrahydropyridine, 2-methylpiperidine, 2,6-dimethylpiperidine, diaminopyridine, tetraethylene pentamine and metaphenylene diamine. Polyoxyalkyleneamines, also, can be used as well as polyethylenimines. Also effective in this invention are epoxide-curing agents such as diethylene triamine, triethylene tetramine, tetraethylene pentamine, polyethylene imine and m-phenylene diamine. Mixtures of said amines can be used. A particularly preferred amine curing agent is piperazine (synonym for diethylenediamine).

In step b) of the process according to the present invention the solid content of the aqueous dispersion is from 1 to 50% by weight, more preferably from 2 to 25% by weight even more preferably from 3 to 13% by weight, an optimum with regard to some conventional rubbers, as outlined hereinafter is reached with a solid content between 4 and 8% by weight in the composition.

The ratios of the components (i), (ii) and (iii) relative to each other in the composition can be varied widely without departing from the scope of the invention.

It is, however, preferred, that the composition exhibits a ratio by weight on a dry weight basis of the sum of the weights of the epoxide and amine components [(ii)+(iii)] to the weight of the latex component (i), and said ratio [(ii)+(iii)]:(i) is in a range from 0.1:1 to 3:1, more preferrably in the range of 0.3:1 to 1:1 and most preferably in the range from 0.5:1 to 1:1.

As is known to the person skilled in the art, the ratio of the epoxide components (ii) to amine components (iii) has to be optimized in order to acquire a dip formulation with sufficient stability in time, i.e. without excessive increase of the viscosity in time or coalescence of the latex particles.

The composition according to the process of the present invention is prepared by dilution of the epoxide component(s) with water, dilution of the amine component(s) with water, and subsequently mixing the above-mentioned diluted components together and add the latex components resulting in an aqueous dispersion. Usually the dispersion is allowed to stand for about 12 hours at room temperature, i.e. undergoing a maturation phase. Afterwards the dispersion is ready to use and can be stored at room temperature or in a refrigerator. The shelf life is usually in the range from 4 to 10 days, but also much longer shelf lifes, up to 30 or even 60 days at room temperature have been witnessed. This fact leads to a considerable increase in shelf life of the dispersion in comparison to the traditional RFL systems.

Step c) of the process according to the present invention consists of drying the reinforcing element treated in step b). Within the scope of the present invention the term “drying” means removing of the water from the aqueous dispersion to an amount that is necessary for the curing step d). The drying can be performed within certain ranges of drying temperature and drying time depending of the water content of the aqueous dispersion and of the geometry of the reinforcing element treated with said dispersion. If for example the treated reinforcing element is a yarn consisting of linear polyphenylene sulfide, a suitable drying temperature is in the range of from 100 to 160° C. and a suitable drying time is in the range from 10 seconds to 240 seconds. If necessary, after said drying the treating step b) can be repeated followed by another drying step c) as included in the step sequence of embodiment 6) according to the present invention's process, wherein the repeated treating and drying can be performed under the same or different conditions than the first treating and drying. Furthermore, during drying the yarns are preferably held under a load, wherein said load preferably is in the range of from 2 mN/tex to 100 mN/tex.

Step d) of the process according to the present invention consists of curing at least components (ii) and (iii) and preferably also (i) resulting in a reinforcing element provided with a cured adhesive composition. Within the scope of the present invention the term “curing” means at least cross-linking of the epoxide component (ii) with the amine curing agent component (iii) to form a cross-linked network. However, depending on the curing conditions also the rubbery latex component (i) can be covalently bond within said network. Said curing can be performed within certain ranges of curing temperature and curing time depending of the geometry of the reinforcing element to be cured. If for example a reinforcing element is a yarn consisting of linear polyphenylene sulfide, a suitable curing temperature is in the range of from 160 to 260° C. and a suitable curing time is in the range from 10 seconds to 240 seconds. Furthermore, during curing the yarns are preferably held under a load, wherein said load preferably is in the range of from 2 mN/tex to 120 mN/tex.

As said before, the steps of the process according to the present invention are performed in certain alternative sequences of steps as defined in the embodiments α) to δ). Because the drying step c) is optional,
embodiment α) comprises the step sequence a), b), d),
embodiment β) comprises the step sequences a), b), c), d), b), d) and a), b), d), b), c), d) and
embodiment δ) comprises the step sequences a), b), c), b), d) and a), b), b), c), d).

The object underlying the present invention is further solved by a reinforcing element provided with a cured adhesive composition and obtained by the process according to the present invention.

The weight percentage of the cured adhesive composition on a dry weight base of the reinforcing element according to the present invention may be in the range from 0.1 to 20% by weight, preferably in the range of up to 20% by weight, more preferably in the range up to 15% by weight and most preferred in the range from 0.1 to 10% by weight on a dry weight basis of said element.

Further, the object underlying the present invention is solved by a rubber article comprising a reinforcing element according to the present invention.

The rubber article according to the present invention and comprising a reinforcing element of the present invention is not restricted in its geometrical shape and may be a pneumatic tire, a belt, an air cushion, a conveyor belt, a rubber vibration insulator, a seal or most preferred a hose.

Although the focus of the present invention is to increase the rubber-adhesion of reinforcing elements comprising sulfur-containing polymers or thermotropic liquid crystalline polymers, it can be expected, that the process according to the present invention can be used for any other reinforcing element shaped e.g. as a yarn, that is difficult to adhere to rubber because of its chemical inertness or very high crystallinity.

The invention is further outlined by the following non-limiting examples.

### EXAMPLE 1

### Manufacture of an Aqueous Dispersion

3.7 g water free piperazine (Deliverer: Acros Organics BVBA, Belgium) is dissolved in 430 g water and mixed using a mechanical stirring apparatus for at least 30 minutes. 19.6 g Epoxide applied as GE 500 having a solid content of 40% by weight (Deliverer: Raschig, Germany) is dissolved in 430 g water and mixed using a mechanical stirring apparatus for at least 30 minutes. The piperazine solution is slowly poured into the epoxide solution and mixed using a mechanical stirring apparatus resulting in an epoxide/amine-mixture. To said mixture 116.7 gram of the rubbery latex Pliocord® VP 106S (solid content: 40% by weight; deliverer Eliokem, France) was added and mixed using a mechanical stirring apparatus.

The resulting 1000 g aqueous dispersion exhibits
a solid content dry weight of 7% by weight,
an amine/epoxide ratio of 0.19 (dry w/w) and
an (epoxide+amine)/latex ratio of 0.5 (dry w/w)
   and is stored for at least 12 hours at room temperature for maturation.

### Manufacture of a Reinforcing Element

A polyphenylene sulfide 1100 dtex Diofort® yarn available by Diolen Industrial Fibers in Germany is assembled and twisted in the construction 1100×2 Z180 on a Lezzeni ring twisting device yielding a reinforcing element being a polyphenylene sulfide (PPS) cord, which was wound on a flange bobbin.

### a) Providing the Reinforcing Element

The PPS-cord is unwound on a Litzeler computreater.

b) Treating the Reinforcing Element with the Aqueous Dispersion

The unwound PPS-cord is treated with the aqueous dispersion using a one-bath dipping procedure with the bath being at room temperature. In said procedure the unwound PPS-cord is dipped in the aqueous dispersion described above.

### c) Drying of the Treated Reinforcing Element

The dipped PPS-cord is dried at 110° C. for 120 seconds at a tension force of 4.5 N.

### d) Curing

The dried PPS-cord is cured at 250° C. for 60 seconds at a tension force of 4.5 N and rewound resulting in a PPS-cord provided with the cured adhesive composition according to the invention.

### EXAMPLE 2

Example 2 was performed as example 1 with the difference, that after step a) the process comprises a two-bath dipping procedure with a first and a second bath both containing the aqueous dispersion as manufactured in example 1 and both being at room temperature.

So, in the process of example 2 the unwound PPS-cord was
dipped in the first bath containing said aqueous dispersion (step b)),
dried at 110° C. for 120 seconds at a tension force of 4.5 N (step c)),
cured at 250° C. for 120 seconds at a tension force of 15.5 N (step d)),
dipped in the second bath containing said aqueous dispersion (step b)), and
cured at 220° C. for 60 seconds at a tension force of 4.5 N (step d))
   resulting in another PPS-cord provided with the cured adhesive composition according to the invention.

### EXAMPLE 3

Example 3 was performed as example 1 with the difference that in step a) the PPS-cord is unwound on a Litzeler computreater and passed through a corona-zone using a double headed HF SpotTEC from Tantec, Denmark with both heads being placed at 2.5 cm from the cord. The cord passes the corona-zone at a speed of 18 m/min.

So, example 3 resulted in a corona-pretreated PPS-cord provided with the cured adhesive composition according to the invention.

### EXAMPLE 4

Example 4 was performed as example 3 with the difference that in step a) the PPS-cord wounded on a bobbin was placed in a bath containing acetone for several minutes before being unwound and passed through the corona-zone. So, example 4 resulted in a pre-washed and corona-pretreated PPS-cord provided with the cured adhesive composition according to the invention.

### REFERENCE EXAMPLE 5

### Reference Predip Composition

This composition consists of
876.4 parts by weight of demineralized water,
20.0 parts by weight of Gum Tragacanth (wetting agent) delivered by Gen Pharma, The Netherlands,
90.0 parts by weight blocked isocyanate Grillbond IL-6 delivered by Raschig
and 13.6 parts by weight GE100 glycerol glycidyl ether.
   Said components are mixed resulting in the reference predip composition.

### Reference RFL Composition

This composition consists of
359.8 parts by weight water,
11.9 parts by weight sodium hydroxide (5% by weight), delivered by Sigma Aldrich,
St. Louis Mo. (USA),
42.4 precondenced RF resin (50% by weight), delivered by Indspec, USA, tradename Penacolite R50 and
20.6 parts by weight formaldehyde (37% by weight), delivered by Boom, The Netherlands.

These ingredients are mixed and the mixture is added to the following mixture:
129.6 parts by weight of demineralized water,
411.0 parts by weight VP-latex (Pliocord VP 106S) (40% solids by weight) and
24.7 part by weight ammonium hydroxide (25% by weight), delivered by Boom, The Netherlands.
   resulting in the reference RFL composition. Said dipping composition is used after at least 12 hours of storage at room temperature.

Reference example 5 was performed as example 2, but with the difference, that the first bath contained the reference predip composition and the second bath contained the reference RFL composition. So, reference example 5 resulted in a PPS-cord provided with a cured adhesive reference composition comprising predip and RFL.

### REFERENCE EXAMPLE 6

Reference example 6 was performed as reference example 5, but with the difference, that the unwound PPS-cord is passed through the same corona-zone as applied in example 3. So, reference example 6 resulted in a corona-pretreated PPS-cord provided with a cured adhesive reference composition comprising predip and RFL.

### EXAMPLE 7

### Manufacture of a Reinforcing Element

A thermotropic liquid crystalline polyester consisting of 73 mol-% p-oxybenzoyl moieties and 27 mol-% of 6-oyx-2-naphthoyl moieties (Vectra® A950 polymer delivered by Ticona, Germany) was spun to a 1100 dtex yarn available by Diolen Industrial Fibers in The Netherlands. Said yarn is assembled and twisted in the construction 1100×2 Z120 on a Lezzeni ring twisting device yielding a reinforcing element being a thermotropic liquid-crystalline polyester-cord (in the following named “LCP-cord”), which was wound on a bobbin.

Example 7 was performed as example 2 with the main difference that—instead of the PPS-cord—the LCP-cord described above was used. So, in the process of example 7 the unwound LCP-cord was
dipped in the first bath containing said aqueous dispersion (step b)),
dried at 110° C. for 120 seconds at a tension force of 2.5 N (step c)),
cured at 240° C. for 45 seconds at a tension force of 2.5 N (step d)),
dipped in the second bath containing said aqueous dispersion (step b)), and
cured at 220° C. for 12 seconds at a tension force of 2.5 N (step d)).
   So, example 7 resulted in an LCP-cord provided with the cured adhesive composition according to the invention.

### REFERENCE EXAMPLE 8

Reference example 8 was performed as reference example 5 with the only difference that—instead of the PPS-cord—the LCP-cord described above was used. So, reference example 8 resulted in a LCP-cord provided with a cured adhesive reference composition comprising predip and RFL.

The PPS-cords of examples 1 to 4 and the LCP-cord of example 7 in each case provided with a cured adhesive composition according to the process of the present invention were wound parallel and embedded in a rubber matrix.

Also the PPS-cords of reference examples 5 and 6 and the LCP-cord of reference example 8 in each case provided with a cured adhesive composition comprising predip and RFL were wound parallel and embedded in a rubber matrix.

Said cords embedded in a rubber matrix were subjected to measurement of SPAF as described in the following:

### Strap Peel Adhesion Force (SPAF) Measurement

As rubber type Dunlop® 5320, commercially available from Goodyear Dunlop Tires GmbH, Germany, was used. Adhesion performance was evaluated by measuring the strap peel adhesion force according to ASTM D 4393-04 with the difference that the strip width is set to 20 mm instead of the 1″ (=25.4 mm) taken in the ASTM D 4393-04. This test method covers the determination of peel adhesion of reinforcing cords that are bonded to rubber compounds. In this peel test the force required to separate two layers of cords vulcanized between thick rubber layers with a thin rubber layer in-between these layers of cords (rubber thickness between 0.9 and 1.2 mm) is measured. This method is known to the skilled person.

Table 1 summarizes the resulting SPAF-values for the said PPS- and LCP-cords provided with a cured adhesive composition according to the process of the present invention (examples 1 to 4 and 7) and of the said PPS- and LCP-cords provided with a cured adhesive composition comprising predip and RFL (reference examples 5, 6 and 8).

TABLE 1

| | | Wash- | | One-bath | Two-bath | SPAF |
|---|---|---|---|---|---|---|
| | Cord | ing | Corona | dipping | dipping | N/2 cm |
| Examples | | | | | | |
| 1 | PPS | − | − | + | − | 65 |
| 2 | PPS | − | − | − | + | 85 |
| 3 | PPS | − | + | + | − | 122 |
| 4 | PPS | + | + | + | − | 189 |
| Reference | | | | | | |
| examples | | | | | | |
| 5 | PPS | − | − | − | + | 30 |
| | | | | | RFL in | |
| | | | | | 2nd bath | |
| 6 | PPS | − | + | − | + | 48 |
| | | | | | RFL in | |
| | | | | | 2nd bath | |
| Example | | | | | | |
| 7 | LCP | − | − | − | + | 100 |
| Reference | | | | | | |
| example | | | | | | |
| 8 | LCP | − | − | − | + | 62 |
| | | | | | RFL in | |
| | | | | | 2nd bath | |

As already mentioned, the one-bath application of the known RFL-mixture to polyphenylene sulfide cords and the incorporation of said RFL-treated polyphenylene cords into a rubber strip results in a SPAF of merely 30 N/2 cm.

Also with two-bath dipping, using a mixture of a blocked isocyanate and an epoxide in the first bath followed by the RFL-treatment in the second bath, the strap peel adhesion force does not increase, as can be seen from reference example 5. Even if additionally a corona pre-treatment is applied to said PPS-cord the SPAF merely increase to 48 N/2 cm as can be seen from reference example 6.

Therefore, it is highly surprising, that the process according to the present invention only with one-bath dipping allows to manufacture a PPS-cord exhibiting a SPAF of 65 N/2 cm (see example 1), which represents an increase of 107%, if compared with the same PPS-cord treated with the known RFL-mixture. With two-bath dipping according to the present invention even an increase in SPAF to 85 N/2 cm can be obtained (see example 2). With one-bath dipping and additionally a corona pre-treatment a SPAF-value of 122 N/2 cm is obtained (see example 3) and, if additionally the PPS-cord is washed with acetone before the corona pre-treatment, a SPAF-value of 189 N/2 cm is obtained (see example 4).

The LCP-cord treated with two-bath dipping with RFL in the 2^{nd} bath exhibits a SPAF-value of 62 N/2 cm (see reference example 8). However, the same LCP-cord treated with two bath dipping according to the process of the present invention shows an SPAF-value of 100 N/2 cm (see example 7).

1. A process to manufacture a reinforcing element provided with a cured adhesive composition, the process comprising:
a) providing a reinforcing element comprising a sulfur-containing polymer or a thermotropic liquid crystalline polymer,
b) treating the reinforcing element provided in step a) with a composition, which comprises an aqueous dispersion of components
(i) at least one rubbery latex component,
(ii) at least one water soluble or dispersible epoxide component, and
(iii) at least one water soluble or dispersible polyfunctional amine curing agent selected from the group consisting of primary, secondary and tertiary amines and mixtures of said amines,
wherein the solid content of the aqueous dispersion is from 1 to 50% by weight, resulting in a treated reinforcing element,
c) optionally drying the treated reinforcing element from step b) resulting in a reinforcing element comprising the components (i), (ii), and (iii), and
d) curing at least components (ii) and (iii),
wherein the steps are performed in the sequence
α) a), b), c), d) or
β) a), b), c), d), b), c), d) or
γ) a), b), d), b), d) or
δ) a), b), c), b), c), d),
resulting in the reinforcing element provided with the cured adhesive composition.

2. The process according to claim 1, wherein the sulfur-containing polymer is a non-crosslinked sulfur-containing polymer.

3. The process according to claim 2, wherein the non-crosslinked sulfur-containing polymer is a non-crosslinked polyarylene sulfide.

4. The process according to claim 3, wherein the non-crosslinked polyarylene sulfide is a linear polyphenylene sulfide.

5. The process according to claim 1, wherein the reinforcing element is fibrous.

6. The process according to claim 5, wherein the reinforcing element is a non-twisted yarn, a twisted yarn, or a cord.

7. The process according to claim 5, wherein the reinforcing element is a woven or knitted fabric.

8. The process according to en claim 1, wherein the composition exhibits a ratio by weight on a dry weight basis of the sum of the weights of the epoxide and amine components [(ii)+(iii)] to the weight of the latex component (i), and said ratio [(ii)+(iii)]:(i) is from 0.1:1 to 3:1.

9. A reinforcing element comprising the cured adhesive composition of claim 1.

10. The reinforcing element according to claim 9, wherein the reinforcing element carries from 0.1 to 20% by weight on a dry weight basis of said element of the cured adhesive composition.

11. A rubber article comprising the reinforcing element according to claim 9.

12. The rubber article according to claim 11, wherein the rubber article is a hose.
